(19) United States
(12) Patent Application Publication
(10) Pub. No.: US 2024/0418612 A1
(43) Pub. Date: Dec. 19, 2024

(54) FULLY AUTOMATIC MAGNETIC SOLID-PHASE EXTRACTION DEVICE

(71) Applicant: Hangzhou Calibra TECHNOLOGIES Co., Ltd., Hangzhou (CN)

(72) Inventors: Sili WU, Hangzhou (CN); Zhibin JI, Hangzhou (CN); Jianbing DU, Hangzhou (CN); Huafen LIU, Hangzhou (CN)

(21) Appl. No.: 18/648,804

(22) Filed: Apr. 29, 2024

(30) Foreign Application Priority Data
Jun. 16, 2023 (CN) 202310719504.8

(51) Int. Cl. G01N 1/34; G01N 35/04; G01N 35/10

(52) U.S. Cl. CPC G01N 1/34; G01N 35/04; G01N 35/1074; G01N 2035/0422; G01N 2035/0479

(57) ABSTRACT

The present invention provides a device capable of conducting magnetic solid-phase extraction, including a framework assembly. The framework assembly includes a platform assembly and an electrical cabinet assembly. The electrical cabinet assembly is disposed below the platform assembly, and an electric assembly is packaged in an electrical cabinet of the electrical cabinet assembly. The electric assembly is disposed independent from the platform assembly. Data wires connected to the electric assembly and the platform assembly are placed in the framework frame or a sheet metal structure, preventing reagents and operations on the platform assembly from polluting or affecting the electric assembly. The present invention designs a magnetic solid-phase extraction device. Pretreating samples in a manner of magnetic solid-phase extraction simplifies the extraction process, reduces the processing costs of the device, and overcomes negative effects caused by some other extraction methods in the background.

### CROSS-REFERENCE TO RELATED APPLICATIONS

This application claims the priority to Chinese Patent Application No. 2023107195048, filed on Jun. 16, 2023, and including but not limited to specification, specification abstract, claims, and specification drawings, which constitute part of the present invention.

### BACKGROUND OF THE INVENTION

### Field of the Invention

The present invention pertains to the technical field of life science devices, and in particular to an automatic device for sample pre-treatment in a manner of magnetic solid-phase extraction.

### Description of the Related Art

In the prior art, a biological sample such as blood needs to be pre-treated before undergoing mass spectrometry analysis. The commonly used extraction methods include liquid-liquid extraction, protein precipitation, solid-phase extraction SPE, and the like. However, these methods during use show some issues or are difficult to achieve automation. For example, the liquid-liquid extraction method typically requires key processes such as centrifugation and nitrogen blowing. Although centrifugation effectively achieves solid-liquid separation of a mixture solution of a sample and a reagent, centrifuges occupy a large volume. In some automatic devices, there is limited space for instrument placement, making it unsuitable to install the centrifuges in the automatic devices. Therefore, most of the liquid-liquid extraction devices on the market mainly operate semi-automatically, with a low degree of automation. Moreover, a single plate (or a single tube) needs to add counterweight during centrifugation, which poses another challenge to the overall design of the device in terms of space and weight. In addition, the liquid-liquid extraction process requires nitrogen blowing during use, and the resulting toxic gases emitted pollute the environment.

Chinese Patent Application No. CN2022109718040 has disclosed a sampling apparatus for sample pre-treatment and a pre-treatment method, where a sample pre-treating device combing solid phase extraction SPE with magnetic solid-phase extraction is disclosed. This device includes both a solid phase extraction SPE module and a magnetic solid-phase extraction module that are replaceable, but the oscillation requirement of the magnetic solid-phase extraction is not fully considered in this device. During magnetic solid-phase extraction, a 96-well plate needs to undergo oscillation in another device and then is manually transferred to the sample pre-treating device. Due to the co-existence of the two modules, the transport assembly moves in a large range, and a gantry is required to move an entire X-axis. And the entire device occupies a large space and the module is also replaced manually. Therefore, in practice, this device is mainly used for solid-phase extraction SPE.

Therefore, it is necessary to develop a magnetic solid-phase extraction device with a high level of automation, to overcome the problems in the background.

### BRIEF SUMMARY OF THE INVENTION

The technical problems to be resolved in the present invention are those in the background, a fully automatic magnetic solid-phase extraction device is provided, simplifying the extraction process, reducing the processing costs of the device and technical difficulties, and reducing problems such as inconvenient operation during use due to a large volume of a centrifuge.

For this, the present invention uses the following technical solution:

The fully automatic magnetic solid-phase extraction device includes a framework assembly. The framework assembly includes a platform assembly and an electrical cabinet assembly. The electrical cabinet assembly is disposed below the platform assembly, and an electric assembly is packaged in an electrical cabinet of the electrical cabinet assembly. The electric assembly is disposed independent from the platform assembly. Data wires connected to the electric assembly and the platform assembly are placed in the framework frame or a sheet metal structure, preventing reagents and operations on the platform assembly from polluting or affecting the electric assembly.

The platform assembly is configured to support functional devices of the fully automatic magnetic solid-phase extraction device.

The platform assembly is provided with a moving assembly, and the moving assembly is configured to drive some or all of the functional devices to move back and forth along a path defined by the moving assembly. In the present invention, there may be one or more moving assemblies, and the quantity of the moving assemblies is set based on the requirement of the functional devices. Or the moving assembly may be a part in the functional device.

The functional devices at least include a sample strip assembly, a consumable station assembly, a pipette assembly, a transport assembly, an oscillation assembly, and a magnetic frame assembly.

The sample strip assembly is configured to carry a sample tube according to a rule; and the consumable station assembly is configured to carry consumables according to a rule, and the consumables at least include reagents and TIP heads.

The transport assembly is disposed for transporting between some or all of the functional devices, and configured to transfer a sample and/or a sample tube between some or all of the functional devices.

Further, the framework assembly includes a framework, the framework includes a frame and a panel, the frame is assembled from an aluminum profile, and a sheet metal member is used as the panel. The frame or the panel may be partially hollow in the middle for wiring or storage.

The framework is provided with an X-axis moving assembly, and the X-axis moving assembly includes an X-axis drive motor, a drive shaft, a driven shaft, an X-axis guide rail, and X-axis timing belts. The X-axis drive motor drives, via the X-axis timing belt, the drive shaft to rotate, and the driven shaft drives, via the drive shaft, the timing belts on two sides to move. The drive shaft and the driven shaft are respectively fixed on two sides of the frame at a certain height on the framework, the X-axis guide rail is disposed between the drive shaft and the driven shaft and configured to guide movement between the drive shaft and the driven shaft, and the X-axis timing belt is wound around one end of the drive shaft and one end of the driven shaft. The X-axis moving assembly further includes an X-axis drag chain, and the X-axis timing belt drives, via the X-axis drag chain, an object to move back and forth between the drive shaft and the driven shaft along the X-axis guide rail.

The X-axis guide rail is configured for mounting a Y-direction moving assembly.

Further, the platform assembly includes a carrying platform disposed below the X-axis moving assembly, and the sample strip assembly, the oscillation assembly, the magnetic frame assembly, the transport assembly, and the consumable station assembly are sequentially disposed on the carrying platform along an X-axis direction.

The consumable station assembly includes a reagent station assembly and a TIP head station assembly. The reagent station assembly includes a reagent holder, the reagent holder is configured for placing reagents including an activation liquid, a balancing liquid, a rinsing liquid, and an elution liquid, the TIP head station assembly includes a TIP head holder, and the TIP head holder is configured for placing TIP heads in the same or different types.

The oscillation assembly and the magnetic frame assembly are arranged side by side along a Y-axis direction, the transport assembly is disposed on a side of the oscillation assembly and the magnetic frame assembly, and the sample strip assembly and the consumable station assembly are respectively disposed on two sides of the oscillation assembly and the magnetic frame assembly.

The platform assembly is further provided with a waste liquid tank, and the waste liquid tank is disposed on a side surface of the oscillation assembly and the magnetic frame assembly. A residual waste liquid after pipetting by a pipetting assembly or a residual waste liquid after magnetic suction can be dripped into the waste liquid tank for later unified disposal.

Further, the oscillation assembly includes a base plate, and the oscillation assembly is fixed onto the carrying platform via the base plate.

The base plate is provided with an oscillation motor and a motor support plate, the motor support plate is disposed above the oscillation motor, the motor support plate is provided with an eccentric wheel for causing oscillation, an output shaft of the oscillation motor extends out of the motor support plate to be connected to the eccentric wheel, an oscillator bracket is disposed above the motor support plate, and the eccentric wheel is connected to the oscillator bracket via a bearing and drives the oscillator bracket to swing for achieving oscillation.

Counterweight blocks are symmetrically connected below the oscillator bracket on two sides, the counterweight blocks are respectively disposed on two sides of the eccentric wheel, two sides of the base plate are respectively provided with a pair of primary connecting rods, a secondary connecting rod is disposed between the primary connecting rods, and the primary connecting rod is connected to the secondary connecting rod via a universal connecting block and configured to support the oscillator bracket and oscillation movement thereof.

The oscillator bracket is provided with a radiator, the radiator is provided with a cooling plate, and the cooling plate is configured to carry a well plate and achieve modular heating and cooling functions.

The oscillation assembly further includes a fan, the fan is disposed at a rear of the oscillation assembly, and an exhaust hood is disposed outside the fan.

Further, the magnetic frame assembly includes a support pillar. The support pillar is fixedly connected below a magnetic-rod mounting plate and configured to support the magnetic-rod mounting plate. The magnetic-rod mounting plate is made of plastic and uniformly provided with a plurality of magnetic rods. The magnetic rods partially extend out of the magnetic-rod mounting plate, a bottom of the magnetic-rod mounting plate is provided with a magnetic-rod adsorption plate, and a bottom of each magnetic rod is fixedly absorbed onto the magnetic-rod adsorption plate. Arrangement position and quantity of the magnetic rods allow a well plate to be mounted on the magnetic frame assembly, the magnetic rod to be disposed between reagent slots of the well plate when the well plate is mounted, and each reagent slot to be surrounded uniformly by four magnetic rods.

Further, the transport assembly includes a transport-assembly base plate, and the transport assembly is fixed to a platform via the transport-assembly base plate. The transport-assembly base plate is provided with a Y-axis transport motor, a Y-axis guide rail, and a Y-axis timing belt. The Y-axis guide rail is disposed above Y-axis timing belt, and the Y-axis transport motor drives, via a band pulley, the Y-axis timing belt to rotate, so as to drive a device or an assembly to move along the Y-axis guide rail.

The transport assembly further includes a gripping assembly, and the gripping assembly includes a gripper and a griper motor. The gripper motor is configured to drive the gripper to grip tightly or release, and the gripper and the gripper motor are mounted on a Z-axis guide rail using a grip-motor support block and are movable up and down along the Z-axis guide rail under drive of a Z-axis screw motor. The Z-axis guide rail is mounted on the Y-axis support frame, and the Y-axis support frame is mounted on the Y-axis guide rail and movable back and forth along a Y axis under action of the Y-axis transport motor and the Y-axis timing belt.

Further, the pipette assembly includes a pipette bracket, a pipetting gun head assembly is mounted in the pipette bracket, the pipetting gun head assembly includes at least four pipetting guns in a grid-like layout, and each two of the four pipetting guns are opposite for combination and arranged side by side.

The pipette bracket is provided with four variable pitch screws and four variable pitch motors in respective correspondence to the four pipetting guns. Each variable pitch motor drives one variable pitch screw, the screws are respectively sleeved in the four pipetting guns, and each variable pitch screw is capable of driving the pipetting gun sleeving it to move back and forth in the pipette bracket, thus achieving movement of the pipetting gun itself and adjusting equidistant positions of the plurality of pipetting guns. In the non-use state, the pipetting guns in the pipette assembly gather up, and the pipette assembly is in a closed state. In this case, the TIP head adapters corresponding to the pipettes also gather up. During use, a variable pitch structure opens the pipette assembly, that is, the plurality of pipettes move outwards at the same time. And during movement to some positions, the distance therebetween is enabled equal by controlling the movement distance and speed of each screw. This is called equidistant transformation. After movement to positions, a distance between positions of the TIP head adapters may be equal to a distance between reagents at reagent stations or a distance between TIP heads at TIP head stations for later operation.

The pipetting gun includes a pipetting-gun fixing block and a pipetting gun body. The pipetting-gun fixing block is configured to carry the pipetting gun body, the pipetting-gun fixing block sleeves the variable pitch screw corresponding to the pipetting gun and is configured to achieve movement and pitch changing of the pipetting gun, the pipette bracket is provided with a Y-axis drag chain, and when the pipette opens or closes, the Y-axis drag chain moves to and from.

Further, the pipette bracket includes two first side plates and four second side plates. The two first side plates are symmetrically arranged in a T-shape on two sides of the pipetting gun head assembly, and the four second side plates are arranged in pairs on the other two sides of the pipetting gun head assembly. One of two second side plates on the same side is fixedly mounted on a T-shaped head side surface of the first side plate, and the other is fixedly mounted on a T-shaped tail side surface of the first side plate. Therefore, a bracket structure with two sides closed and the other two sides hollow is formed. The variable pitch motor is disposed outside one of the first side plates, and the first side plate forms a support assembly of a variable pitch structure.

Further, a collection tray is also disposed below the pipette assembly, bottoms of the two first side plates are provided with collection tray guide rails, a collection tray motor is disposed outside one of the first side plates, the collection tray motor drives, via a collection tray timing belt, a gear to rotate, the collection tray guide rail is provided with a rack, and the gear meshes with the rack to drive the collection tray to move below the pipette assembly.

Further, the pipetting gun head assembly includes a pipetting-gun connecting block corresponding to each pipetting gun, and the pipetting gun body is fixedly connected to the pipetting-gun connecting block.

The pipetting-gun fixing block is provided with a pipette Z-axis mounting plate, the pipette Z-axis mounting plate is provided with a pipette Z-axis timing belt and a pipette Z-axis timing pulley, and one end of the pipette Z-axis mounting plate is fixedly mounted with a pipette Z-axis screw. The pipetting-gun connecting block sleeves the pipette Z-axis screw, the pipette Z-axis screw is disposed on a side of the pipetting-gun fixing block, and a pipette Z-axis motor is fixedly mounted on the other side of the pipetting-gun fixing block. The pipette Z-axis motor drives, via the pipette Z-axis timing pulley and the pipette Z-axis timing belt, the pipette Z-axis screw to rotate, so as to drive the pipetting-gun connecting block to move up and down along the pipette Z-axis screw. An inverted U-shaped pipette Z-axis drag chain is disposed between the pipette Z-axis screw and the pipette Z-axis motor and configured to guide pipetting-gun connecting block to move on the pipette Z-axis screw.

The pipetting gun body includes a pipette body. An upper end of the pipette body is provided with a piston motor, a pipetting screw, a pipetting screw sleeve, a piston rod, a piston sleeve, and a sealing assembly are disposed downwards in the pipette body, and a lower end of the pipette body is connected to a TIP head adapter via a pressure sensor shell. A bottom of the pressure sensor shell is provided with a TIP head docking portion, the TIP head docking portion is provided with an oblique channel therein and configured to communicate with both an outlet of the lower end of the pipette body and the TIP head adapter via the oblique channel, and a pressure sensor is provided on a side of the oblique channel.

A pressure sensor circuit board is disposed in the pressure sensor shell and configured to be connectable to a pressure sensor and to receive sense data thereof.

Adjacent two of the TIP head docking portions are staggered, such that all the TIP head adapters are linearly arranged on a middle line between the pipette bodies.

The present invention has the following beneficial effects: (1) A magnetic solid-phase extraction device is designed in the present invention. Pretreating samples in a manner of magnetic solid-phase extraction simplifies the extraction process, reduces the processing costs of the device, and overcomes negative effects caused by some other extraction methods in the background. (2) Except feeding, the other processes can be independently finished by the device. The present invention basically achieves full automation, resolving the problem in the prior art that full automation cannot be achieved, reducing the labor costs, and improving the device efficiency. (3) In the present invention, during design, the oscillation module and the magnetic solid-phase extraction module are arranged side by side. The design of the oscillation module achieves automatic oscillation before magnetic solid-phase extraction. In addition, the oscillation mechanism in the present invention is designed particularly for a well plate. The eccentric structure and the counterweight satisfy the size and quality requirements of the well plate and do not add burden to the device in terms of counterweight. (4) The pipettes in the present invention are arranged in a grid-like layout and save more space for the device than the linearly arranged pipettes. In terms of the grid-like pipette arrangement and the linear TIP head arrangement. connection is made using the oblique channel and adjacent structures staggered, allowing for a more impacted and ingenious structure and the fitting relationship in the structure enables the entire structure to be more stable. (5) The pipette in the present invention is provided with a screw and a piston. The screw can drive the piston to achieve automatic liquid suction and discharge functions, and each piston is equipped with one screw motor and can independently achieve automatic liquid suction and discharge functions. Moreover, in the present invention, the pressure sensor shell is disposed at the nozzle of the pipetting gun, such that issues such as clogging and bubble formation at the pipetting gun can be detected, ensuring smooth operation of the device. The magnetic bead method is the development trend of solid-phase extraction and features low costs and simple process steps. Therefore, developing a magnetic solid-phase extraction device is of great significance.

### BRIEF DESCRIPTION OF THE DRAWINGS

FIG. 1 is a schematic diagram of an entire structure according to the present invention.

FIG. 2 is a schematic structural diagram of a framework assembly according to the present invention.

FIG. 3 is a schematic structural diagram of a platform assembly according to the present invention.

FIG. 4 is a schematic diagram of an entire structure of an oscillation assembly according to the present invention.

FIG. 5 is a schematic diagram of a side structure of an oscillation assembly according to the present invention.

FIG. 6 is a cross-sectional view of an oscillation assembly along A-A according to the present invention.

FIG. 7 is a schematic diagram of an entire structure of a magnetic frame assembly according to the present invention.

FIG. 8 is a local cross-sectional view of a side surface in FIG. 7.

FIG. 9 is a schematic diagram of a combination between a magnetic frame assembly and a well plate according to the present invention.

FIG. 10 is a top view of FIG. 9.

FIG. 11 is a schematic diagram of an entire structure of a transport assembly according to the present invention.

FIG. 12 is a schematic diagram of the transport assembly at another angle according to the present invention.

FIG. 13 is a schematic diagram of an entire structure of a pipette assembly according to the present invention.

FIG. 14 is a schematic diagram of the pipette assembly at another angle according to the present invention.

FIG. 15 is a side view of the pipette assembly according to the present invention.

FIG. 16 is a schematic diagram of a pipetting gun head assembly according to the present invention.

FIG. 17 is a schematic diagram of a pipetting gun according to the present invention.

FIG. 18 is a cross-sectional view of the pipetting gun according to the present invention.

FIG. 19 is a cross-sectional view of FIG. 18 along B-B.

Numeral references in the accompanying drawings: framework assembly 100, platform assembly 101, electrical cabinet assembly 102, moving assembly 103, frame 104, panel 105, X-axis moving assembly 106, X-axis drive motor 107, drive shaft 108, driven shaft 109, X-axis guide rail 110, X-axis timing belt 111, X-axis drag chain 112, carrying platform 113, waste liquid tank 114, control/display panel 115, sample strip assembly 201, consumable station assembly 202, pipette assembly 203, transport assembly 204, oscillation assembly 205, magnetic frame assembly 206, reagent station assembly 207, TIP head station assembly 208, reagent holder 209, TIP head station 210, scanner 211, TIP head holder 212, pipette bracket 2031, pipetting gun head assembly 2032, pipetting gun 2033, variable pitch screw 2034, variable pitch motor 2035, pipetting-gun fixing block 2036, pipetting gun body 2037, Y-axis drag chain 2038, first side plate 2039, second side plate 2130, collection tray 2131, collection tray guide rail 2132, collection tray motor 2133, collection tray timing belt 2134, gear 2135, rack 2136, pipetting-gun connecting block 2137, fastener 2138, pipette Z-axis mounting plate 2139, pipette Z-axis timing belt 2140, pipette Z-axis timing pulley 2141, pipette Z-axis screw 2142, pipette Z-axis motor 2143, pipette Z-axis drag chain 2144, pipette body 2145, piston motor 2146, pipetting screw 2147, pipetting screw sleeve 2148, piston rod 2149, piston sleeve 2150, sealing assembly 2151, pressure sensor shell 2152, TIP head adapter 2153, TIP head docking portion 2154, oblique channel 2155, pressure sensor 2156, pressure sensor circuit board 2157, variable-pitch-motor mounting plate 2158, pipette Z-axis bearing 2159, pipette screw bearing 2160, pipette outlet 2161, transport-assembly base plate 2041, Y-axis transport motor 2042, Y-axis guide rail 2043, Y-axis timing belt 2044, Y-axis transport pulley 2045, gripper 2046, gripper motor 2047, grip-motor support block 2048, Z-axis guide rail 2049, Z-axis screw motor 2140, Y-axis support frame 2141, pipette Z-axis screw 2142, base plate 2051, oscillation motor 2052, motor support plate 2053, eccentric wheel 2054, output shaft 2055, oscillator bracket 2056, bearing 2057, counterweight block 2058, primary connecting rod 2059, secondary connecting rod 2060, universal connecting block 2152, radiator 2153, cooling plate 2154, fan 2155, exhaust hood 2156, support pillar 2061, magnetic-rod mounting plate 2062, magnetic rod 2063, magnetic-rod adsorption plate 2064, well plate 300, and reagent slot 301.

### DETAILED DESCRIPTION OF THE INVENTION

To make the objectives, technical solutions, and advantages of this application more comprehensible, the following describes this application in detail with reference to accompanying drawings and embodiments. It should be understood that the specific embodiments described herein are merely used to explain this application but are not intended to limit this application. All other embodiments obtained by persons of ordinary skill in the art based on the embodiments provided in this application without creative efforts shall fall within the protection scope of this application.

In this application, references to “embodiments” mean that the specific features, structures, or characteristics described in the embodiments can be included in at least one embodiment of this application. The presence of this term at various positions in the specification does not necessarily refer to the same embodiment, nor does it imply an exclusive or alternative embodiment that is mutually exclusive from other embodiments. Those of ordinary skill in the art would understand, explicitly and implicitly, that the embodiments described in this application can be combined with other embodiments without the conflict case.

Unless otherwise defined, the technical or scientific terms used here should be understood in their usual sense by those of ordinary skill in the art to which this application belongs. The terms “one”, “a”, “a type of”, “this”, and similar expressions used in this application do not imply a limitation on quantity and can represent a singular or plural form. The terms “include”, “comprise”, “have”, and any variations thereof used in this application are intended to encompass non-exclusive inclusion. The terms “connect”, “interconnect” “couple”, and similar expressions used in this application are not limited to physical or mechanical connections but may include electrical connection, no matter whether it is direct or indirect. “A plurality of” involved in this application indicates being greater than or equal to two.

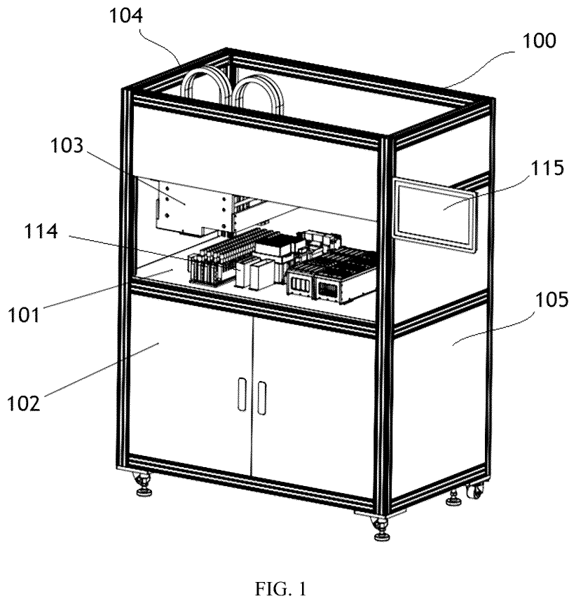

As shown in FIG. 1, the present invention provides a fully automatic magnetic solid-phase extraction device including a framework assembly 100. The framework assembly includes a platform assembly 101 and an electrical cabinet assembly 102. The electrical cabinet assembly 102 is disposed below the platform assembly 101. A device and a functional member related to the electricity are packaged in an electrical cabinet of the electrical cabinet assembly. The electric assembly is disposed independent from the platform assembly. Data wires connected to the electric assembly and the platform assembly are placed in the framework frame or a sheet metal structure, preventing reagents and operations on the platform assembly from polluting or affecting the electric assembly.

The platform assembly 101 is configured to support functional devices of the magnetic solid-phase extraction device. The functional devices at least include a sample strip assembly 201, a consumable station assembly 202, a pipette assembly 203, a transport assembly 204, an oscillation assembly 205, and a magnetic frame assembly 206.

The platform assembly is provided with a moving assembly 103, and the moving assembly 103 is configured to drive some or all of the functional devices to move back and forth along a path defined by the moving assembly 103. In the present invention, there may be one or more moving assemblies, and the quantity of the moving assemblies is set based on the requirement of the functional devices. Or the moving assembly may be a part in the functional device. In terms of the specific structure, the moving assembly 103 in the present invention may be a mechanical arm, a mechanical part with a gripping function, or the like.

A scanner 211 is disposed on a side of the sample strip assembly 201. After a sample strip is disposed at the sample strip assembly 201, a scanner 207 scans code and inputs information about the sample strip for later track and record in the later process.

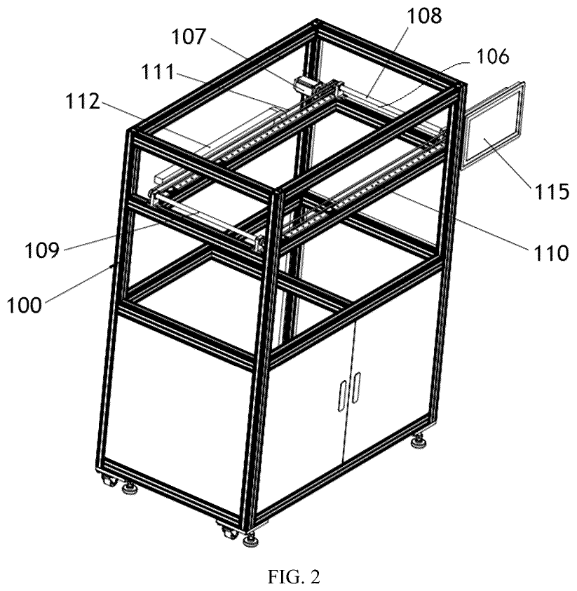

As shown in FIG. 2, the framework assembly includes a framework, the framework includes a frame 104 and a panel 105, the frame 104 is assembled from an aluminum profile, and a sheet metal member is used as the panel 105. The frame 104 or the panel 105 may be partially hollow in the middle for wiring or storage. A control/display panel 115 is disposed on a side of the framework.

The framework assembly 100 is provided with an X-axis moving assembly 106, and the X-axis moving assembly 106 includes an X-axis drive motor 107, a drive shaft 108, a driven shaft 109, an X-axis guide rail 110, and X-axis timing belts 111. The X-axis drive motor 107 drives, via the X-axis timing belt 111, the drive shaft 108 to rotate, and the driven shaft 109 drives, via the drive shaft 108, the X-axis timing belts 111 on two sides to move. The drive shaft 108 and the driven shaft 109 are respectively fixed on two sides of the frame 104 at a certain height on the framework, the X-axis guide rail 110 is disposed between the drive shaft 108 and the driven shaft 109 and configured to guide movement between the drive shaft 108 and the driven shaft 109, and the X-axis timing belt 111 is wound around one end of the drive shaft 108 and one end of the driven shaft 109. The X-axis moving assembly 106 further includes an X-axis drag chain 112, and the X-axis timing belt 111 drives, via the X-axis drag chain 112, an object to move back and forth between the drive shaft 108 and the driven shaft 109 along the X-axis guide rail 110. Another assembly for movement in the direction Y or Z may be also mounted on the X-axis guide rail 110.

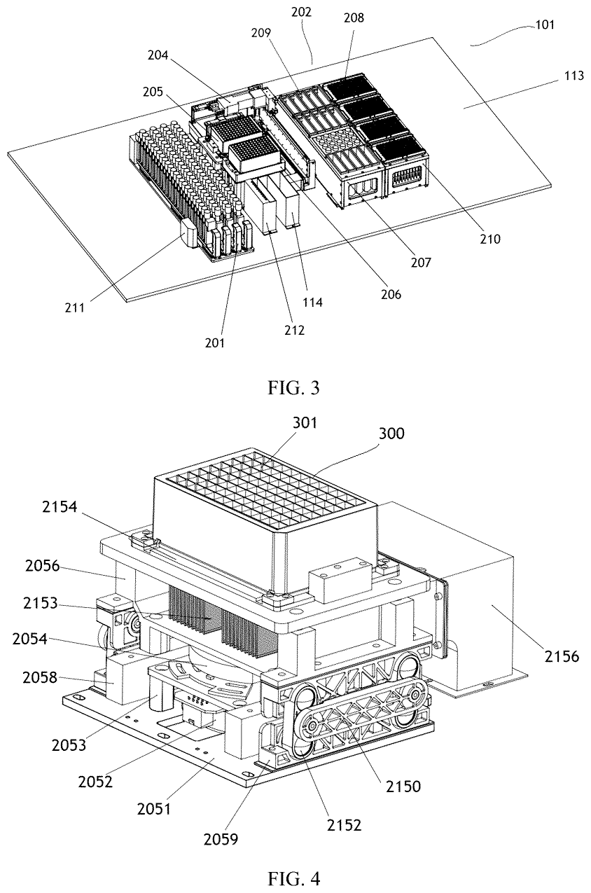

As shown in FIG. 3, the platform assembly 101 includes a carrying platform 113 disposed below the X-axis moving assembly, and the sample strip assembly 201, the oscillation assembly 205, the magnetic frame assembly 206, the transport assembly 204, and the consumable station assembly 202 are sequentially disposed on the carrying platform 113 along an X-axis direction. The consumable station assembly 202 includes a reagent station assembly 207 and a TIP head station assembly 208. The reagent station assembly 207 includes a reagent holder 209. and the reagent holder 209 is configured for placing reagents (reagent tubes) including an activation liquid, a balancing liquid, a rinsing liquid, and an elution liquid. The TIP head station assembly 208 includes TIP head stations 210, and the TIP head stations 210 are configured for placing TIP heads in the same or different types. In the present invention, 50-microliter and 100-microliter TIP heads with filter cartridges are used.

The oscillation assembly 205 and the magnetic frame assembly 206 are arranged side by side on the carrying platform 113 along a Y-axis direction, the transport assembly 204 is disposed on a side of the oscillation assembly 205 and the magnetic frame assembly 206, and the sample strip assembly 201 and the consumable station assembly 202 are respectively disposed on two sides of the oscillation assembly 205 and the magnetic frame assembly 206. The platform assembly 101 is further provided with a waste liquid tank 114, and the waste liquid tank 114 is disposed on a side surface of the oscillation assembly 205 and the magnetic frame assembly 206. A residual waste liquid after pipetting by a pipetting assembly or a residual waste liquid after magnetic suction can be dripped into the waste liquid tank 114 for later unified disposal. In addition, after pipetting using the pipette, the used TIP head may be placed in a TIP head holder 212.

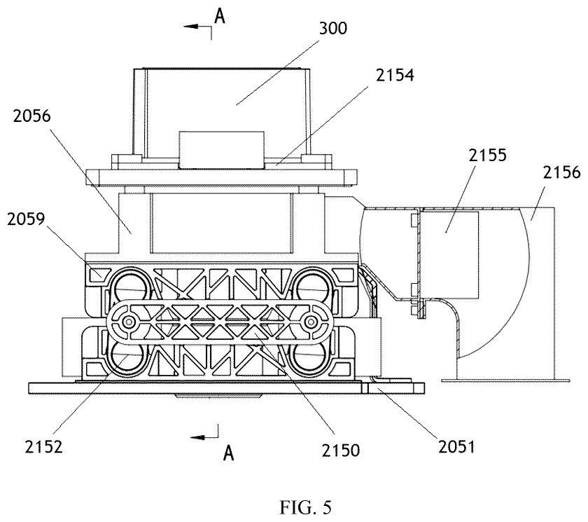

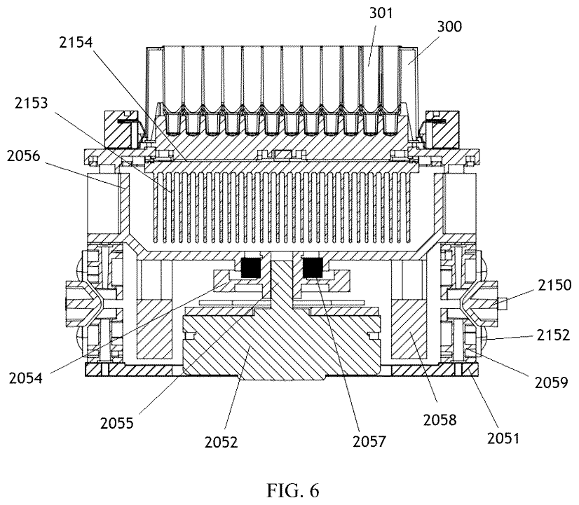

As shown in FIGS. 4 to 6, the oscillation assembly 205 includes a base plate 2051, and the oscillation assembly 205 is fixed onto the carrying platform 113 via the base plate 2051. The base plate 2051 is provided with an oscillation motor 2052 and a motor support plate 2053. The motor support plate 2053 is disposed above the oscillation motor 2052, and the motor support plate 2053 is provided with an eccentric wheel 2054 for causing oscillation. An output shaft 2055 of the oscillation motor 2052 extends out of the motor support plate 2053 to be connected to the eccentric wheel 2054. An oscillator bracket 2056 is disposed above the motor support plate 2053. The eccentric wheel 2054 is connected to the oscillator bracket 2056 via a bearing 2057. When the oscillation motor 2052 outputs, the eccentric wheel 2054 drives, via the bearing 2057, the oscillator bracket 2056 to swing for achieving oscillation. As shown in FIG. 4, when the well plate 200 is placed on the oscillation assembly 205, oscillation can be achieved in the foregoing manner.

Counterweight blocks 2058 are symmetrically connected below the oscillator bracket 2056 on two sides, the counterweight blocks 2058 are respectively disposed on two sides of the eccentric wheel 2054, two sides of the base plate 2051 are respectively provided with a pair of primary connecting rods 2059. That is, upper and lower primary connecting rods 2059 are disposed on one side. A secondary connecting rod 2060 is disposed between the primary connecting rods 2059, and the primary connecting rod 2059 is connected to the secondary connecting rod 2060 via a universal connecting block 2152 (a spherical connection hole) and configured to support the oscillator bracket 2056 and oscillation movement thereof. The oscillator bracket 2056 is further provided with a radiator 2153, the radiator 2153 is provided with a cooling plate 2154, and the cooling plate 2154 is configured to carry a well plate 300 and achieve a function of heating and/or cooling the well plate 300 based on the actual requirements. For example, when the temperature is excessively high during oscillation, the cooling plate 2154 can perform cooling. Or when a specified temperature is required during mixing for pre-treatment but the retrieved reagent has an excessively low temperature, the cooling plate 2154 can also perform heating to some extent.

The oscillation assembly 205 further includes a fan 2155, and the fan is disposed at a rear of the oscillation assembly 205 and configured to remove potential contaminant gases generated during reaction. An exhaust hood 2156 is disposed outside the fan and can perform exhausting outside the device and/or house through an externally connected pipe.

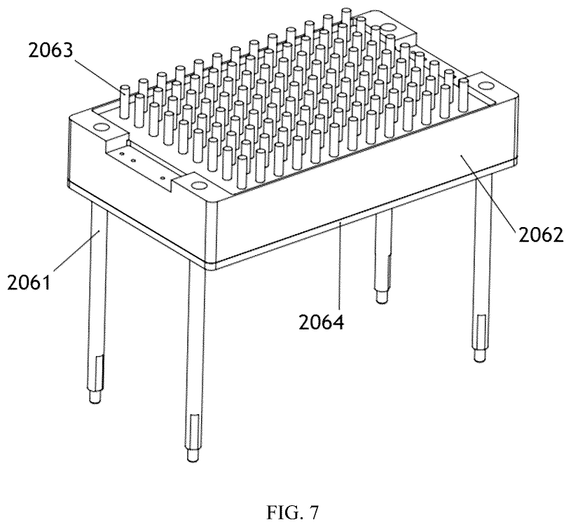

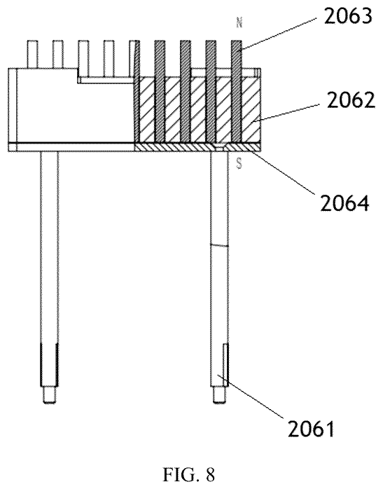

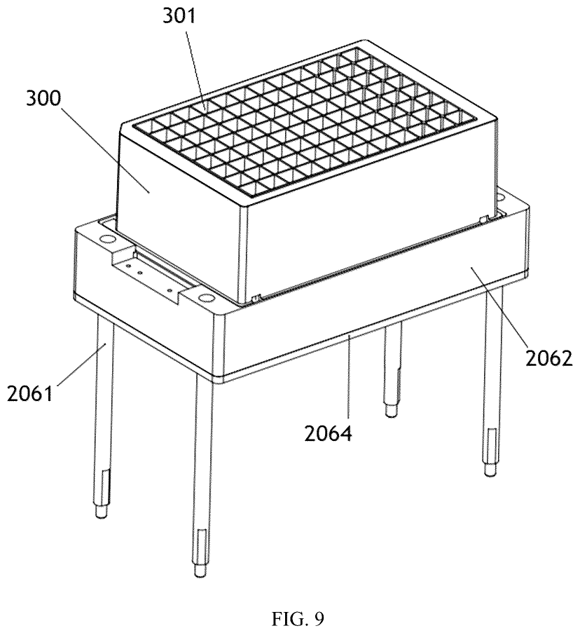

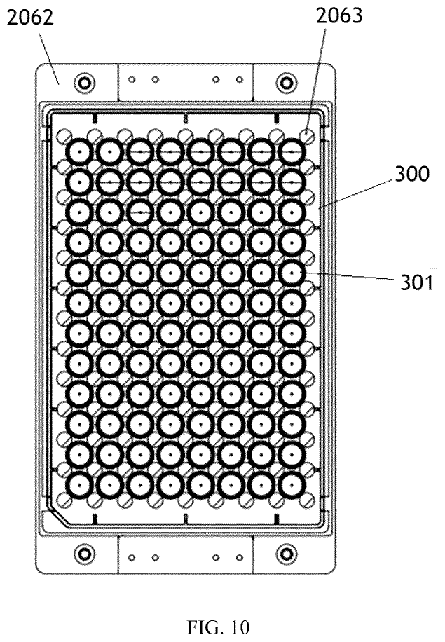

As shown in FIGS. 7 to 10, the magnetic frame assembly 206 includes a support pillar 2061. The support pillar 2061 is fixedly connected below a magnetic-rod mounting plate 2062 and configured to support the magnetic-rod mounting plate 2062. The magnetic-rod mounting plate 2062 is made of POM engineering plastic and uniformly provided with a plurality of magnetic rods 2063. The magnetic rods 2063 partially extend out of the magnetic-rod mounting plate 2062, a bottom of the magnetic-rod mounting plate 2062 is provided with a magnetic-rod adsorption plate 2064, and a bottom of each magnetic rod 2063 is fixedly absorbed onto the magnetic-rod adsorption plate 2064 through magnetic suction. Arrangement position and quantity of the magnetic rods 2063 allow a well plate 300 to be mounted on the magnetic frame assembly 206 (in a nested manner), the magnetic rod 2063 to be nested between reagent slots 301 (holes) of the well plate 300 when the well plate is mounted, and each reagent slot to be surrounded uniformly by four magnetic rods 2063. In the present invention, a 96 deep-well plate (8×12) is used. According to the foregoing requirements, there is an extra circle of magnetic rods beyond the perimeter of the well plate, meaning the number of magnetic rods is 9×13, as shown in FIG. 10.

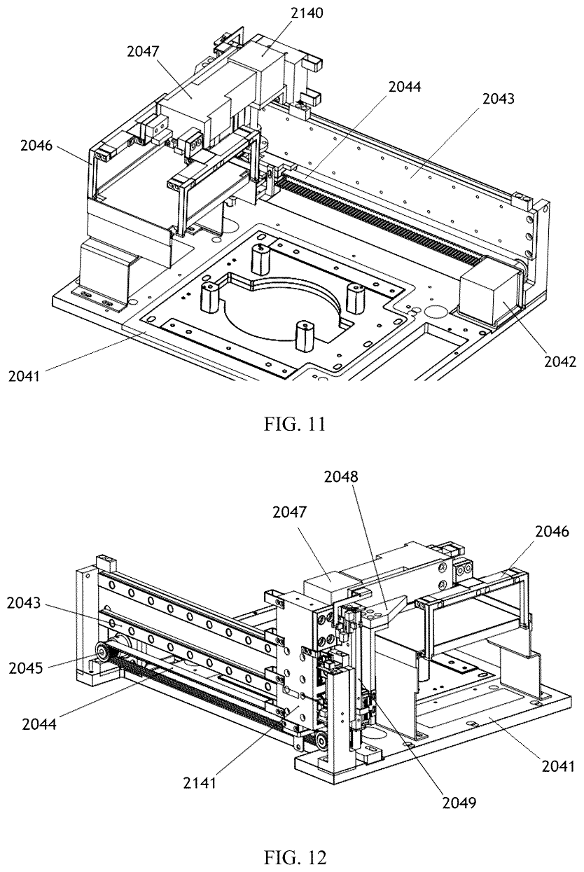

As shown in FIGS. 11 and 12, the transport assembly 204 includes a transport-assembly base plate 2041, and the transport assembly 204 is fixed to the platform assembly 101 via the transport-assembly base plate 2041. The transport-assembly base plate 2041 is provided with a Y-axis transport motor 2042, a Y-axis guide rail 2043, and a Y-axis timing belt 2044. The Y-axis guide rail 2043 is disposed above Y-axis timing belt 2044, and the Y-axis transport motor 2042 drives, via a Y-axis transport pulley 2045, the Y-axis timing belt 2044 to rotate, so as to drive the transport assembly to move along the Y-axis guide rail 2043.

The transport assembly 204 further includes a gripping assembly, and the gripping assembly includes a gripper 2046 and a griper motor 2047. The gripper motor 2047 is configured to drive the gripper 2046 to grip tightly or release, and the gripper 2046 and the gripper motor 2047 are mounted on a Z-axis guide rail 2049 using a grip-motor support block 2048 and are movable up and down along the Z-axis guide rail 2049 under drive of a Z-axis screw motor 2140. The Z-axis guide rail 2049 is mounted on the Y-axis support frame 2141, and the Y-axis support frame 2141 is mounted on the Y-axis guide rail 2043 and movable back and forth along a Y axis under action of the Y-axis transport motor 2042 and the Y-axis timing belt 2044.

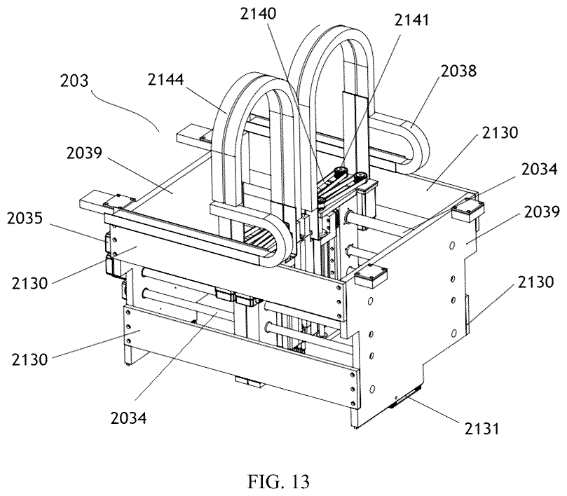

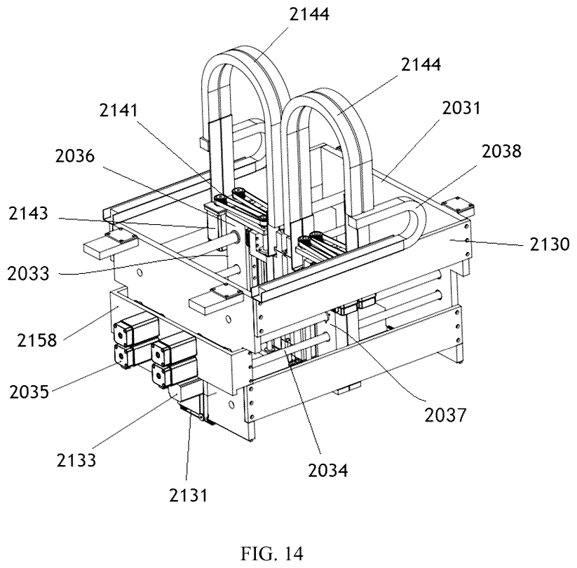

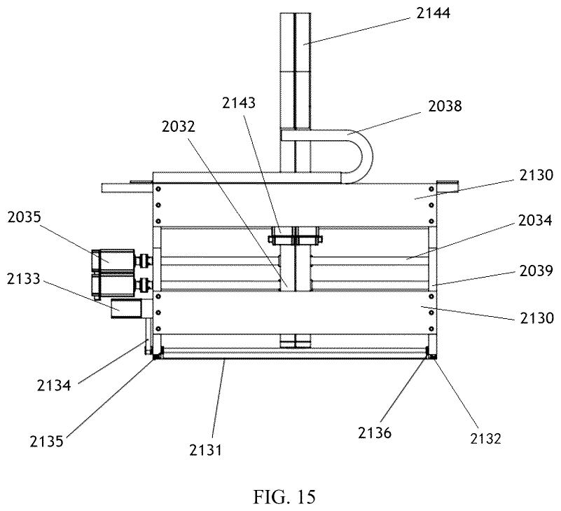

As shown in FIGS. 13 to 15, the pipette assembly 203 includes a pipette bracket 2031, a pipetting gun head assembly 2032 is mounted in the pipette bracket 2031, the pipetting gun head assembly 2032 includes at least four pipetting guns 2033 in a grid-like layout, and each two of the four pipetting guns 2033 are opposite for combination and arranged side by side. In other words, two of the pipetting guns 2033 are opposite and form a set. In this embodiment, two sets of opposite pipetting guns 2033 are provided, forming a pipetting gun combination with one each on the top, bottom, left, and right. Certainly, a plurality of sets may be alternatively arranged, for example, three sets or four sets. This manner, compared with the linear arrangement in the prior art, saves more space and results in a smaller length. In addition, the two pipetting guns in one set are opposite and can share a partial structure, also saving the space in the width direction.

The pipette bracket 2031 is provided with four variable pitch screws 2034 and four variable pitch motors 2035 in respective correspondence to the four pipetting guns 2033. The variable pitch motor 2035 is fixedly mounted on a first side plate 2039 using a variable-pitch-motor mounting plate 2158. Each variable pitch motor 2035 drives one variable pitch screw 2034. Certainly, if the quantity of the pipetting guns increases, the quantities of the variable pitch screws and the variable pitch motors also increase accordingly. The variable pitch screws 2034 are respectively sleeved in the four pipetting guns 2033. Due to the case of arranging the pipetting guns side by side, one variable pitch screw 2034 inevitably penetrates through more than one pipetting gun, but adjusts only one pipetting gun. Therefore, the variable pitch screws can be arranged with different diameters, and the corresponding pipetting guns have different pore sizes to fit with the variable pitch screws, with those on two sides arranged symmetrical. In other words, each set of pipetting guns correspond to the size of one variable pitch screw. For example. in the present invention, two types of variable pitch screws in different sizes are needed.

As described before, each variable pitch screw 2034 is capable of driving the pipetting gun 2033 sleeving it to move back and forth in the pipette bracket 2031, thus achieving movement of the pipetting gun 2033 itself and adjusting equidistant positions of the plurality of pipetting guns 2033. In the non-use state, the pipetting guns in the pipette assembly 203 gather up, and the pipette assembly is in a closed state. In this case, the TIP head adapters corresponding to the pipettes also gather up. During use, a variable pitch structure opens the pipette assembly, that is, the plurality of pipettes move outwards at the same time. And during movement to some positions, the distance therebetween is enabled equal by controlling the movement distance and speed of each screw. This is called equidistant transformation. After movement to positions, a distance between positions of the TIP head adapters may be equal to a distance between reagents at reagent stations or a distance between TIP heads at TIP head stations for later operation.

In addition, the pipetting gun 2033 includes a pipetting-gun fixing block 2036 and a pipetting gun body 2037. The pipetting-gun fixing block 2036 is configured to carry the pipetting gun body, the pipetting-gun fixing block 2036 sleeves the variable pitch screw 2034 corresponding to the pipetting gun 2033 and is configured to achieve movement and pitch changing of the pipetting gun 2033, the pipette bracket 2031 is provided with a Y-axis drag chain 2038, and when the pipette opens or closes, the Y-axis drag chain 2038 moves to and from.

Preferably, the pipette bracket 2031 includes two first side plates 2039 and four second side plates 2130. The two first side plates 2039 are symmetrically arranged in a T-shape on two sides of the pipetting gun head assembly 2032, and the four second side plates 2130 are arranged in pairs on the other two sides of the pipetting gun head assembly 2032. One of two second side plates 2130 on the same side is fixedly mounted on a T-shaped head side surface of the first side plate 2039, and the other is fixedly mounted on a T-shaped tail side surface of the first side plate 2039. Therefore, a bracket structure with two sides closed and the other two sides hollow is formed. The bracket structure results in a large upper part and a small lower part of the entire pipette assembly, which facilitates the arrangement of the space structure, and the side structure being hollow also facilitates structural inspection and maintenance. The variable pitch motor 2035 is disposed outside one of the first side plates 2039, and the first side plate 2039 forms a support assembly of a variable pitch structure.

Preferably, a collection tray 2131 is also disposed below the pipette assembly 203. bottoms of the two first side plates 2039 are provided with collection tray guide rails 2132, a collection tray motor 2133 is disposed outside one of the first side plates, the collection tray motor 2133 drives, via a collection tray timing belt 2134, a gear 2135 to rotate, the collection tray guide rail 2132 is provided with a rack 2136, and the gear 2135 meshes with the rack 2136 to drive the collection tray 2131 to move below the pipette assembly 203.

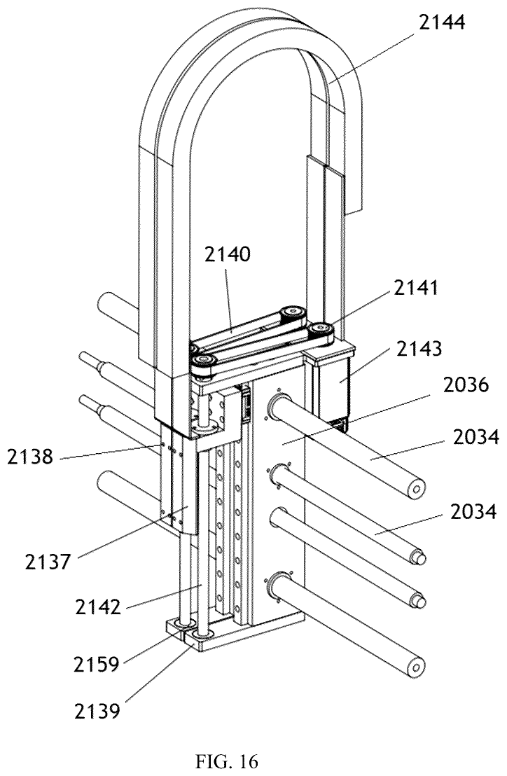

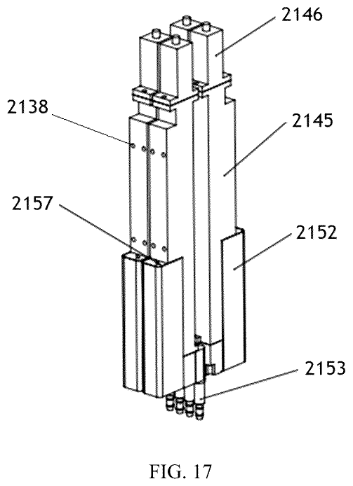

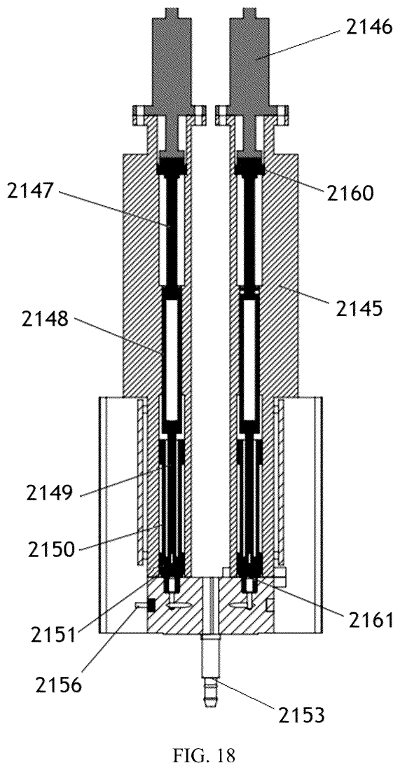

As shown in FIGS. 16 to 19, the pipetting gun head assembly 2032 includes a pipetting-gun connecting block 2137 corresponding to each pipetting gun 2033, and the pipetting gun body 2037 is fixedly connected to the pipetting-gun connecting block 2137 via a fastener 2138 on a side surface.

The pipetting-gun fixing block 2036 is provided with a pipette Z-axis mounting plate 2139, the pipette Z-axis mounting plate 2139 is provided with a pipette Z-axis timing belt 2140 and a pipette Z-axis timing pulley 2141, and one end of the pipette Z-axis mounting plate 2139 is mounted with a pipette Z-axis screw 2142 via a pipette Z-axis bearing 2159. The pipetting-gun connecting block 2137 sleeves the pipette Z-axis screw 2142, the pipette Z-axis screw 2142 is disposed on a side of the pipetting-gun fixing block 2036, and a pipette Z-axis motor 2143 is fixedly mounted on the other side of the pipetting-gun fixing block 2036. The pipette Z-axis motor 2143 drives, via the pipette Z-axis timing pulley 2141 and the pipette Z-axis timing belt 2140, the pipette Z-axis screw 2142 to rotate, so as to drive the pipetting-gun connecting block 2137 to move up and down along the pipette Z-axis screw 2142. An inverted U-shaped pipette Z-axis drag chain 2144 is disposed between the pipette Z-axis screw 2142 and the pipette Z-axis motor 2143 and configured to guide pipetting-gun connecting block 2137 to move on the pipette Z-axis screw 2142.

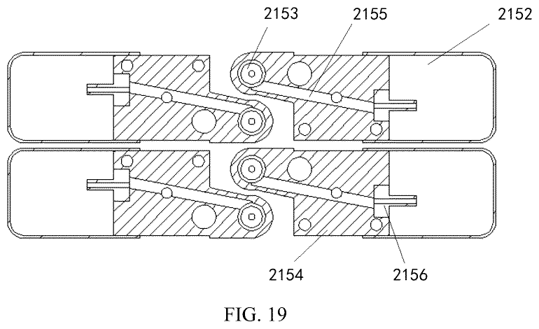

The pipetting gun body 2037 includes a pipette body 2145. An upper end of the pipette body 2145 is provided with a piston motor 2146, a pipette screw bearing 2160, a pipetting screw 2147, a pipetting screw sleeve 2148, a piston rod 2149, a piston sleeve 2150, and a sealing assembly 2151 are disposed downwards in the pipette body 2145, and a lower end of the pipette body 2145 is connected to a TIP head adapter 2153 via a pressure sensor shell 2152. A bottom of the pressure sensor shell 2152 is provided with a TIP head docking portion 2154, the TIP head docking portion 2154 is provided with an oblique channel 2155 therein and configured to communicate with both an outlet 2161 of the lower end of the pipette body 2145 and the TIP head adapter 2153 via the oblique channel 2155, and a pressure sensor 2156 is provided on a side of the oblique channel 2155. As shown in FIG. 19, the head of the pressure sensor 2156 is located in the oblique channel 2155 and its outer end extends into the pressure sensor shell 2152. A pressure sensor circuit board 2157 is disposed in the pressure sensor shell 2152 and can receive its sense data, so as to feed back the data to a control center. When the pressure drops or exceeds a threshold, the pressure sensor triggers an alarm to ensure the normal operation of the device.

In addition, to make the device more compacted, as shown in FIG. 19, two adjacent TIP head docking portions 2154 are staggered, such that all the TIP head adapters 2153 are linearly arranged on a middle line between the pipetting gun bodies 2037. This can ensure that the pipette bodies 2145 in the same set can share one pressure sensor shell 2152 and that the pipetting gun bodies 2037 cooperate with each other.

The process of the present invention is as follows: A sample strip is inserted into the sample strip assembly 201 in advance, a TIP head carrying frame is placed at the TIP head station assembly 208, a reagent is correspondingly placed at the reagent station assembly 207, a new 96 deep-well plate 300 is placed in a vacant station of the transport assembly 204, and the gripping assembly transports and then places the 96 deep-well plate 300 on the oscillation assembly 205. Then, a specified amount of reagent is drawn using the pipette assembly 203 after movement to the corresponding reagent station and added into each well of the 96 deep-well plate. Next, the oscillation assembly 205 performs vortex oscillation for a period of time for mixing to uniformity. Then, the gripping assembly transports the 96 deep-well plate onto a magnetic frame for magnetic absorption operation. After left standing for 2 to 3 min, the reagent in each well of the 96 deep-well plate is drawn using the pipette into the waste liquid tank. Subsequently, a mechanical arm transports the 96 deep-well plate back to the oscillation position for the next operation, to undergo several subsequent corresponding similar procedures: activation, equilibration, sample loading, washing 1, washing 2, and elution, until the overall operation of the sample pre-treatment ends.

1. A fully automatic magnetic solid-phase extraction device, comprising a framework assembly, wherein
the framework assembly comprises a platform assembly and an electrical cabinet assembly, wherein
the platform assembly is configured to support functional devices of the fully automatic magnetic solid-phase extraction device;
the platform assembly is provided with a moving assembly, and the moving assembly is configured to drive some or all of the functional devices to move back and forth along a path defined by the moving assembly; and
the functional devices at least comprise a sample strip assembly, a consumable station assembly, a pipette assembly, a transport assembly, an oscillation assembly, and a magnetic frame assembly, wherein
the sample strip assembly is configured to carry a sample tube according to a rule; and the consumable station assembly is configured to carry consumables according to a rule, and the consumables at least comprise reagents and TIP heads; and
the transport assembly is disposed for transporting between some or all of the functional devices, and configured to transfer a sample and/or a sample tube between some or all of the functional devices.

2. The fully automatic magnetic solid-phase extraction device according to claim 1, wherein the framework assembly comprises a framework, the framework comprises a frame and a panel, the framework is assembled from an aluminum profile, and a sheet metal member is used as the panel;
the framework is provided with an X-axis moving assembly, and the X-axis moving assembly comprises an X-axis drive motor, a drive shaft, a driven shaft, an X-axis guide rail, and X-axis timing belts, wherein the X-axis drive motor drives, via the X-axis timing belt, the drive shaft to rotate, and the driven shaft drives, via the drive shaft, the timing belts on two sides to move; the drive shaft and the driven shaft are respectively fixed on two sides of the frame at a certain height on the framework, the X-axis guide rail is disposed between the drive shaft and the driven shaft and configured to guide movement between the drive shaft and the driven shaft, the X-axis timing belt is wound around one end of the drive shaft and one end of the driven shaft, the X-axis moving assembly further comprises an X-axis drag chain, and the X-axis timing belt drives, via the X-axis drag chain, an object to move back and forth between the drive shaft and the driven shaft along the X-axis guide rail; and
the X-axis guide rail is configured for mounting a Y-direction moving assembly.

3. The fully automatic magnetic solid-phase extraction device according to claim 2, wherein the platform assembly comprises a carrying platform disposed below the X-axis moving assembly, and the sample strip assembly, the oscillation assembly, the magnetic frame assembly, the transport assembly, and the consumable station assembly are sequentially disposed on the carrying platform along an X-axis direction;
the consumable station assembly comprises a reagent station assembly and a TIP head station assembly, wherein the reagent station assembly comprises a reagent holder, the reagent holder is configured for placing reagents comprising an activation liquid, a balancing liquid, a rinsing liquid, and an elution liquid, the TIP head station assembly comprises a TIP head holder, and the TIP head holder is configured for placing TIP heads in the same or different types;
the oscillation assembly and the magnetic frame assembly are arranged side by side along a Y-axis direction, the transport assembly is disposed on a side of the oscillation assembly and the magnetic frame assembly, and the sample strip assembly and the consumable station assembly are respectively disposed on two sides of the oscillation assembly and the magnetic frame assembly; and
the platform assembly is further provided with a waste liquid tank, and the waste liquid tank is disposed on a side surface of the oscillation assembly and the magnetic frame assembly.

4. The fully automatic magnetic solid-phase extraction device according to claim 2, wherein the oscillation assembly comprises a base plate, and the oscillation assembly is fixed onto the carrying platform via the base plate;
the base plate is provided with an oscillation motor and a motor support plate, the motor support plate is disposed above the oscillation motor, the motor support plate is provided with an eccentric wheel for causing oscillation, an output shaft of the oscillation motor extends out of the motor support plate to be connected to the eccentric wheel, an oscillator bracket is disposed above the motor support plate, and the eccentric wheel is connected to the oscillator bracket via a bearing and drives the oscillator bracket to swing for achieving oscillation;
counterweight blocks are symmetrically connected below the oscillator bracket on two sides, the counterweight blocks are respectively disposed on two sides of the eccentric wheel, two sides of the base plate are respectively provided with a pair of primary connecting rods, a secondary connecting rod is disposed between the primary connecting rods, and the primary connecting rod is connected to the secondary connecting rod via a universal connecting block and configured to support the oscillator bracket and oscillation movement thereof;
the oscillator bracket is provided with a radiator, the radiator is provided with a cooling plate, and the cooling plate is configured to carry a well plate and achieve modular heating and cooling functions; and
the oscillation assembly further comprises a fan, the fan is disposed at a rear of the oscillation assembly, and an exhaust hood is disposed outside the fan.

5. The fully automatic magnetic solid-phase extraction device according to claim 1, wherein the magnetic frame assembly comprises a support pillar, the support pillar is fixedly connected below a magnetic-rod mounting plate and configured to support the magnetic-rod mounting plate, the magnetic-rod mounting plate is made of plastic and uniformly provided with a plurality of magnetic rods, the magnetic rods partially extend out of the magnetic-rod mounting plate, a bottom of the magnetic-rod mounting plate is provided with a magnetic-rod adsorption plate, a bottom of each magnetic rod is fixedly absorbed onto the magnetic-rod adsorption plate, and arrangement position and quantity of the magnetic rods allow a well plate to be mounted on the magnetic frame assembly, the magnetic rod to be disposed between reagent slots of the well plate when the well plate is mounted, and each reagent slot to be surrounded uniformly by four magnetic rods.

6. The fully automatic magnetic solid-phase extraction device according to claim 1, wherein the transport assembly comprises a transport-assembly base plate, the transport assembly is fixed to a platform via the transport-assembly base plate, the transport-assembly base plate is provided with a Y-axis transport motor, a Y-axis guide rail, and a Y-axis timing belt, the Y-axis guide rail is disposed above Y-axis timing belt, and the Y-axis transport motor drives, via a band pulley, the Y-axis timing belt to rotate, so as to drive a device or an assembly to move along the Y-axis guide rail; and
the transport assembly further comprises a gripping assembly, the gripping assembly comprises a gripper and a griper motor, the gripper motor is configured to drive the gripper to grip tightly or release, the gripper and the gripper motor are mounted on a Z-axis guide rail using a grip-motor support block and are movable up and down along the Z-axis guide rail under drive of a Z-axis screw motor, the Z-axis guide rail is mounted on the Y-axis support frame, and the Y-axis support frame is mounted on the Y-axis guide rail and movable back and forth along a Y axis under action of the Y-axis transport motor and the Y-axis timing belt.

7. The fully automatic magnetic solid-phase extraction device according to claim 1, wherein the pipette assembly comprises a pipette bracket, a pipetting gun head assembly is mounted in the pipette bracket, the pipetting gun head assembly comprises at least four pipetting guns in a grid-like layout, and each two of the four pipetting guns are opposite for combination and arranged side by side;
the pipette bracket is provided with four variable pitch screws and four variable pitch motors in respective correspondence to the four pipetting guns, each variable pitch motor drives one variable pitch screw, the screws are respectively sleeved in the four pipetting guns, and each variable pitch screw is capable of driving the pipetting gun sleeving it to move back and forth in the pipette bracket, thus achieving movement of the pipetting gun itself and adjusting equidistant positions of the plurality of pipetting guns; and
the pipetting gun comprises a pipetting-gun fixing block and a pipetting gun body, the pipetting-gun fixing block is configured to carry the pipetting gun body, the pipetting-gun fixing block sleeves the variable pitch screw corresponding to the pipetting gun and is configured to achieve movement and pitch changing of the pipetting gun, the pipette bracket is provided with a Y-axis drag chain, and when the pipette opens or closes, the Y-axis drag chain moves to and from.

8. The fully automatic magnetic solid-phase extraction device according to claim 7, wherein the pipette bracket comprises two first side plates and four second side plates, the two first side plates are symmetrically arranged in a T-shape on two sides of the pipetting gun head assembly, the four second side plates are arranged in pairs on the other two sides of the pipetting gun head assembly, one of two second side plates on the same side is fixedly mounted on a T-shaped head side surface of the first side plate, the other is fixedly mounted on a T-shaped tail side surface of the first side plate, and the variable pitch motor is disposed outside one of the first side plates.

9. The fully automatic magnetic solid-phase extraction device according to claim 8, wherein a collection tray is also disposed below the pipette assembly, bottoms of the two first side plates are provided with collection tray guide rails, a collection tray motor is disposed outside one of the first side plates, the collection tray motor drives, via a collection tray timing belt, a gear to rotate, the collection tray guide rail is provided with a rack, and the gear meshes with the rack to drive the collection tray to move below the pipette assembly.

10. The fully automatic magnetic solid-phase extraction device according to claim 7, wherein the pipetting gun head assembly comprises a pipetting-gun connecting block corresponding to each pipetting gun, and the pipetting gun body is fixedly connected to the pipetting-gun connecting block;
the pipetting-gun fixing block is provided with a pipette Z-axis mounting plate, the pipette Z-axis mounting plate is provided with a pipette Z-axis timing belt and a pipette Z-axis timing pulley, one end of the pipette Z-axis mounting plate is fixedly mounted with a pipette Z-axis screw, the pipetting-gun connecting block sleeves the pipette Z-axis screw, the pipette Z-axis screw is disposed on a side of the pipetting-gun fixing block, a pipette Z-axis motor is fixedly mounted on the other side of the pipetting-gun fixing block, the pipette Z-axis motor drives, via the pipette Z-axis timing pulley and the pipette Z-axis timing belt, the pipette Z-axis screw to rotate, so as to drive the pipetting-gun connecting block to move up and down along the pipette Z-axis screw, and an inverted U-shaped pipette Z-axis drag chain is disposed between the pipette Z-axis screw and the pipette Z-axis motor and configured to guide pipetting-gun connecting block to move on the pipette Z-axis screw;
the pipetting gun body comprises a pipette body, an upper end of the pipette body is provided with a piston motor, a pipetting screw, a pipetting screw sleeve, a piston rod, a piston sleeve, and a sealing assembly are disposed downwards in the pipette body, a lower end of the pipette body is connected to a TIP head adapter via a pressure sensor shell, a bottom of the pressure sensor shell is provided with a TIP head docking portion, the TIP head docking portion is provided with an oblique channel therein and configured to communicate with both an outlet of the lower end of the pipette body and the TIP head adapter via the oblique channel, and a pressure sensor is provided on a side of the oblique channel;
a pressure sensor circuit board is disposed in the pressure sensor shell and configured to be connectable to a pressure sensor and to receive sense data thereof; and
adjacent two of the TIP head docking portions are staggered, such that all the TIP head adapters are linearly arranged on a middle line between the pipette bodies.
